(19) United States
(12) Patent Application Publication
(10) Pub. No.: US 2026/0261699 A1
(43) Pub. Date: Sep. 3, 2026

(54) TRANSPORTING MULTIMEDIA IMMERSION AND INTERACTION DATA IN A WIRELESS COMMUNICATION SYSTEM

(71) Applicant: LENOVO (SINGAPORE) PTE. LTD., Singapore (SG)

(72) Inventors: Razvan-Andrei STOICA, Essen (DE); Dimitrios KARAMPATSIS, Ruislip (GB)

(21) Appl. No.: 19/164,516

(22) PCT Filed: May 16, 2023
(86) PCT No.: PCT/EP2023/063122

§ 371 Date: Sep. 11, 2025

(30) Foreign Application Priority Data
Mar. 15, 2023 (GR) 20230100212

(51) Int. Cl. H04N 19/467; H04L 65/65; H04N 19/70

(52) U.S. Cl. CPC H04N 19/467; H04L 65/65; H04N 19/70

(57) ABSTRACT

There is provided, a method of wireless communication in a wireless communication system. The method comprises generating, using one or more media sources, one or more data units of multimedia immersion and interaction data; encoding, using a video codec, an encoded video stream, the encoded video stream comprising as non-video coded embedded metadata, the one or more data units of multimedia immersion and interaction data; and transmitting, using a real-time transport protocol, the encoded video stream.

### FIELD

The subject matter disclosed herein relates generally to the field of implementing transporting multimedia immersion and interaction data in a wireless communication system. This document defines apparatuses and methods for wireless communication in a wireless communication system.

### INTRODUCTION

Interactive and immersive multimedia communications imply various information flows carrying potentially time-sensitive inputs from one terminal to be transported over a network to a remote terminal. Applications relying on such multimedia modes of communication become more and more popular with massive online games, cloud gaming and extended Reality (XR) expansion through the markets. The multimedia information flows often go beyond the traditional video and audio flows and include further formats of following categories: device capabilities, media description, and spatial interaction information, respectively. These are communicated over heterogeneous networks to or from graphic rendering engines and user devices. These media and data types are thus fundamental to the successful implementation of truly immersive and interactive applications that process user input information and return reactions based in part on the exciting user inputs under a set of delay constraints.

XR is used as an umbrella term for different types of realities, according to 3GPP Technical Report TR 26.928 (v17.0.0—April 2022). These types of realities include, Virtual Reality (VR), Augmented Reality (AR) and Mixed Reality (MR).

VR is a rendered version of a delivered visual and audio scene. The rendering is in this case designed to mimic the visual and audio sensory stimuli of the real world as naturally as possible to an observer or user as they move within the limits defined by the application. Virtual reality usually, but not necessarily, requires a user to wear a head mounted display (HMD), to completely replace the user's field of view with a simulated visual component, and to wear headphones, to provide the user with the accompanying audio. Some form of head and motion tracking of the user in VR is usually also necessary to allow the simulated visual and audio components to be updated to ensure that, from the user's perspective, items and sound sources remain consistent with the user's movements. In some implementations additional means to interact with the virtual reality simulation may be provided but are not strictly necessary.

AR is when a user is provided with additional information or artificially generated items, or content overlaid upon their current environment. Such additional information or content will usually be visual and/or audible and their observation of their current environment may be direct, with no intermediate sensing, processing, and rendering, or indirect, where their perception of their environment is relayed via sensors and may be enhanced or processed.

MR is an advanced form of AR where some virtual elements are inserted into the physical scene with the intent to provide the illusion that these elements are part of the real scene.

XR refers to all real-and-virtual combined environments and human-machine interactions generated by computer technology and wearables. It includes representative forms such as AR, MR and VR and the areas interpolated among them. The levels of virtuality range from partially sensory inputs to fully immersive VR. A key aspect of XR is the extension of human experiences especially relating to the senses of existence (represented by VR) and the acquisition of cognition (represented by AR).

Central to the success of an immersive XR experience are the interaction and spatial computing associated with an XR application activity. This applies similarly to other mainstream interaction-driven applications, such as Cloud Gaming (CG). The interaction data and associated spatial computing determining the XR rendering engine or CG gaming engine responses to the user physical inputs, contribute thus to a cyber-physical illusion of immersiveness between the physical and virtual worlds.

The data such applications carry and leverage to generate the cyber-physical immersiveness illusion has been categorized into a number of classes as set out in 3GPP Technical Document S4-221557 (November 2022), or alternatively, Technical Report TR 26.926 (v1.1.0—February 2022). This includes a device capability class, a media description class, and an interaction and immersion metadata class.

In the device capability class, the formats associated with this data class describe the physical and hardware capabilities of an end user equipment (UE) and/or glass device. Some examples in this sense are camera sub-system capabilities and camera configuration (e.g., focal length, available zoom, and depth calibration information, pose reference of the main camera etc.), projection formats (e.g., cubemap, equirectangular, fisheye, stereographic etc.). The device capability data is usually static and available before the establishment of a session, hence its transfer and transport over a network is not of high concern as it can be embedded in typical session configuration procedures and protocols, such as Session Initiation Protocol (SIP) and/or Session Description Protocol (SDP). The device capability data is as such not real-time sensitive and has no real-time transport requirements.

In the media description class, the data describes the space and/or the object content of a view. For instance, this data can be a scene description used to detail the 3D composition of space anchoring 2D and 3D objects within a scene (e.g., as a tree or graph structure usually of glTF2.0 or JSON syntax). Another possible representation is of a spatial description used for spatial computing and mapping of the real-world to its virtual counterpart or vice versa. In some other examples, this data type may contain 3D model descriptors of objects and their attributes formatted for instance as meshes (i.e., sets of vertices, edges and faces), or point cloud data formatted under POLYgon (PLY) syntax to be consumed by the visual presentation devices, i.e., the UEs. Other data types may represent dynamic world graph representations whereby selected trackables (e.g., geo-cached AR/QR codes, geo-trackables like physical objects located at a specified world position, dynamic physical objects like buses, subways, etc.) enter and leave the scene perspective of the world dynamically and need to be conveyed in real-time to an AR runtime. The media description class of data may be of large size (i.e., often even more than 10 MBytes) and it may be updated with low frequency (within 10s of seconds regime) under various event triggers (e.g., user viewport change, new object entering the scene, old object exiting the scene, scene change and/or update etc.). The media description data may be real-time sensitive as it is involved in completing the display of the virtual renderings to a presentation device such as a UE, and as a result may benefit of real-time transport over a network.

In the interaction and immersion metadata class, this data type contains user spatial interaction information such as: user viewport description (i.e., an encoding of azimuth, elevation, tilt, and associated ranges of motion describing the projection of the user view to a target display); user field of view (FoV) (i.e., the extent of the visible world from the viewer perspective usually described in angular domain, e.g., radians/degrees, over vertical and horizontal planes); user pose/orientation tracking data (i.e., micro-/nanosecond timestamped 3D vector for position and quaternion representation for orientation describing up to 6DoF); user gesture tracking data (i.e., an array of hands tracked each consisting of an array of hand joint locations relative to a base space);

user body tracking data (e.g., a BioVision Hierarchical BVH encoding of the body and body segments movements); user facial expression/eye movement tracking data (e.g., as an array of key points/features positions or their encoding to pre-determined facial expression classes); user actionable inputs (e.g., OpenXR actions capturing user inputs to controllers or HW command units supported by an AR/VR device); split-rendering pose and spatial information (e.g., pose information containing the pose information used by a split-rendering server to pre-render an XR scene, or alternatively, a scene projection as a video frame); application and AR anchor data and description (i.e., metadata determining the position of an object or a point in the user space as an anchor for placing virtual 2D/3D objects, such as text renderings, 2D/3D photo/video content etc.).

### SUMMARY

In general, the interaction and immersion class data has certain characteristics. These characteristics include: low data footprint ranging usually from 32 Bytes up to around hundreds of Bytes per message with no established codecs for compression of data sources; high sampling rates varying between the video FPS frequency, e.g., 60 Hz up to 250 Hz, and in some cases wherein sample aggregation is not performed raw sample reports may be transmitted even at 1000 Hz sampling frequency; data can trigger a response with low-latency requirements (e.g., up to 50 milliseconds end-to-end from the interaction to the response as perceived by the user); can be synchronized to other media streams (e.g., video or audio media stream); can be synchronized to other interaction data (e.g., pose information may be synchronized with user actions, or alternatively, object actions); reliability is optional as determined by individual application requirements' (e.g., in split-rendering scenarios servers may predict future pose estimates based on available pose information and hence high reliability below 10\hat{ }(−3) error rate is not necessary); data encoding follows usually proprietary/non-standardized or rapidly evolving application- and interaction-dependent formats (e.g., formats and transport containers for the plethora of metadata are not yet fully defined and/or specified); carries privacy sensitive interaction events and data such as: user pose/gaze, user inputs/actions, and/or user hand gestures or body orientation.

The interaction and immersion metadata class is therefore real-time sensitive and requires real-time transport over a network on par with existent solutions for established media flows pertaining to video, or alternatively, audio codecs.

Furthermore, in XR multimedia information flows, the format and syntax of such information flows is often application, platform and/or HW dependent and in contradiction to well-established media formats and codecs (e.g., audio or video codecs), no mainstream encodings, syntax and semantics are well established. Furthermore, no mainstream transport specific solutions have been established yet as such information flows and associated data formats evolve rapidly. The latter fact requires fast adaptation to new versions at a higher rate than typical conventional media codecs development cycles. This motivates the search for transport solutions over a network of such information flows in a real time, flexible and encoding-/syntax-agnostic manner to provide application developers necessary modern tools for fast emerging and disruptive interactive applications.

Currently, the media description and interaction data benefitting real-time transmission and synchronization may be in some implementations transmitted based on at least three different options based on existing technologies. These technologies are: WebRTC data channel based on the Stream Control Transmission Protocol (SCTP); RTP header extension embedding the metadata information in-band in the RTP transport (for example, U.S. Patent Application No. 63/420,885); and new RTP payload format generically dedicated to the transport of real-time metadata (for example, U.S. Patent Application No. 63/478,932).

A potential solution for the first technology (discussed in 3GPP Tdoc S4-221557) comprises the SCTP data channel of the WebRTC being used to carry interaction metadata. A generic data channel payload format for timed metadata including a timestamp is added to the chunk user data section of the SCTP data channel. This is a flexible option for metadata transport since it allows carriage of metadata not directly associated to media and enables differentiation in terms of reliability, priority, and ordering requirements by setting up data channels with different properties. It relies on IETF established protocols and available technologies within the market today. On the downside, there is no inherent timing, synchronization, and jitter support and FEC mechanisms are missing in case of SCTP.

In case of the second technology a potential solution (discussed in 3GPP Tdoc S4-221555, or alternatively, U.S. Patent Application No. 63/420,885) comprises a RTP header extension designed to carry interaction metadata of limited size while its associated media content is carried in the RTP payload. Support for a single metadata type or multiple metadata types can be carried in the proposed header extension to allow for scalability and flexibility. This approach has the advantage that the transported metadata is time-synchronized to the media data. Moreover, all the robustness and timing mechanisms provided by RTP are included (e.g., synchronization, jitter, congestion control support, FEC mechanisms etc.). However, it only makes sense if a media stream exists, which is often the case for AR or VR specific use cases aided by split-rendering. In case no media streams are present, transmission of RTP packets with empty/dummy payloads would however be required. Another concern is the potentially large size of the RTP headers, depending on the metadata type. RTP header extensions can also be silently ignored by a receiver if the latter is unable to process them.

In case of the third technology, the usage of a separate RTP stream where the interaction metadata is carried in the RTP payload is possible (as proposed in U.S. Patent Application No. 63/478,932). In RTP, the details of media encoding, such as signal sampling rate, frame size and timing, are specified in RTP payload formats. Hence, sending interaction metadata in a separate RTP stream is based on defining a new RTP payload format for interaction metadata whereby a generic RTP metadata payload dedicated to the transport of different interaction and immersion metadata is formulated. The advantage of this approach is that it enables the usage of all RTP mechanisms (timing, synchronization, jitter management support as well as FEC robustness etc) while providing a generic format that can cover all types of interaction metadata. This requires carry over in IETF to become a universal transport standard. However, definition of a new payload format typically takes at least two years in IETF meaning that for 3GPP, or alike, networked systems, the developed format would at the earliest be useful at the end of the 3GPP Release 19 cycle, or alternatively, in the medium-term.

Of interest therefore, are solutions for transporting multimedia interaction and immersion data, that cater for diverse multimedia data types (e.g., media description, interaction and immersion metadata classes and their subcategories), including various syntax and formats, various data sizes (e.g., from hundreds of Bytes to tens of MBytes), various timed data generation (e.g., from periodically generated with strict timing to event-based data), and real-time synchronization constraints.

Disclosed herein are procedures for transporting multimedia interaction and immersion data, in a wireless communication system. Said procedures may be implemented by apparatuses and methods for wireless communication in a wireless communication system.

There is provided an apparatus for wireless communication in a wireless communication system, comprising: a processor; and a memory coupled with the processor, the processor configured to cause the apparatus to: generate, using one or more media sources, one or more data units of multimedia immersion and interaction data; encode, using a video codec, an encoded video stream, the encoded video stream comprising as non-video coded embedded metadata, the one or more data units of multimedia immersion and interaction data; and transmit, using a real-time transport protocol, the encoded video stream.

There is further provided an apparatus for wireless communication in a wireless communication system, comprising: a processor; and a memory coupled with the processor, the processor configured to cause the apparatus to: receive, using a real-time transport protocol, an encoded video stream, the encoded video stream being encoded using a video codec, wherein the encoded video stream comprises as non-video coded embedded metadata, one or more data units of multimedia immersion and interaction data generated by one or more media sources; decode, using the video codec, the encoded video stream, wherein the decoding comprises extracting the non-video coded embedded metadata; and consume, from the non-video coded embedded metadata, the one or more data units of multimedia immersion and interaction data.

There is further provided a method of wireless communication in a wireless communication system, comprising: generating, using one or more media sources, one or more data units of multimedia immersion and interaction data; encoding, using a video codec, an encoded video stream, the encoded video stream comprising as non-video coded embedded metadata, the one or more data units of multimedia immersion and interaction data; and transmitting, using a real-time transport protocol, the encoded video stream.

There is further provided a method for wireless communication in a wireless communication system, comprising: receiving, using a real-time transport protocol, an encoded video stream, the encoded video stream being encoded using a video codec, wherein the encoded video stream comprises as non-video coded embedded metadata, one or more data units of multimedia immersion and interaction data generated by one or more media sources; decoding, using the video codec, the encoded video stream, wherein the decoding comprises extracting the non-video coded embedded metadata; and consuming, from the non-video coded embedded metadata, the one or more data units of multimedia immersion and interaction data.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for transporting multimedia interaction and immersion data in a wireless communication system will now be described, by way of example only, with reference to the accompanying drawings, in which:

FIG. 1 illustrates an embodiment of a wireless communication system;

FIG. 2 illustrates an embodiment of a user equipment apparatus;

FIG. 3 illustrates an embodiment of a network node;

FIG. 4 illustrates an RTP and RTCP protocol stack over IP networks;

FIG. 5 illustrates a WebRTC (SRTP) protocol stack over IP networks;

FIG. 6 illustrates an RTP packet format and header information;

FIG. 7 illustrates an SRTP packet format and header information;

FIG. 8 illustrates an RTP/SRTP header extension format and syntax;

FIG. 9 illustrates a simplified block diagram of a generic video codec performing spatial and temporal compression of a video source;

FIG. 10 illustrates a video coded elementary stream and corresponding plurality of NAL units;

FIG. 11 illustrates an embodiment of a method of wireless communication in a wireless communication system;

FIG. 12 illustrates an alternative embodiment of a method of wireless communication in a wireless communication system;

FIG. 13 illustrates a representation of multimedia interaction and immersion user data as metadata within a video coded elementary stream for MPEG H-26x family of video codecs; and

FIG. 14 illustrates a representation of multimedia interaction and immersion user data as metadata within a video coded elementary stream for the AV1 video codec.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

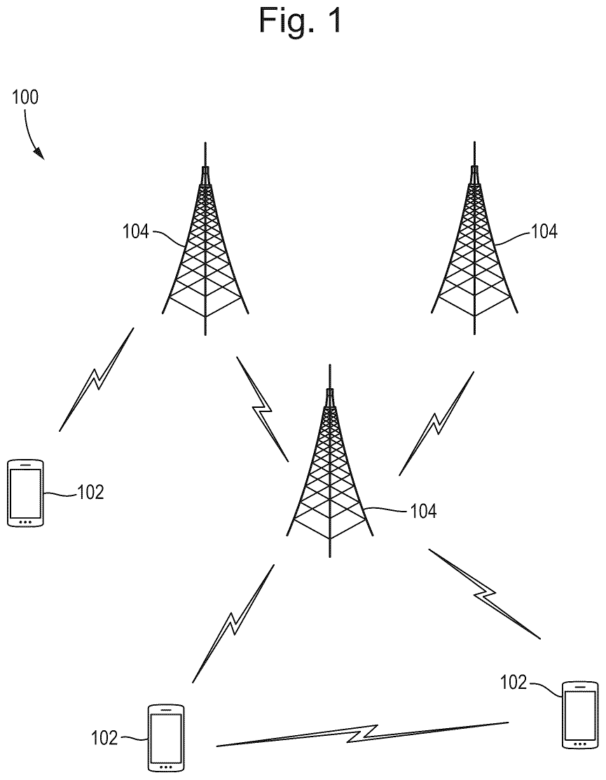

FIG. 1 depicts an embodiment of a wireless communication system 100 for transporting multimedia immersion and interaction data. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100. The wireless communication system may comprise a wireless communication network and at least one wireless communication device. The wireless communication device is typically a 3GPP User Equipment (UE). The wireless communication network may comprise at least one network node. The network node may be a network unit.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfox, LoraWAN among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

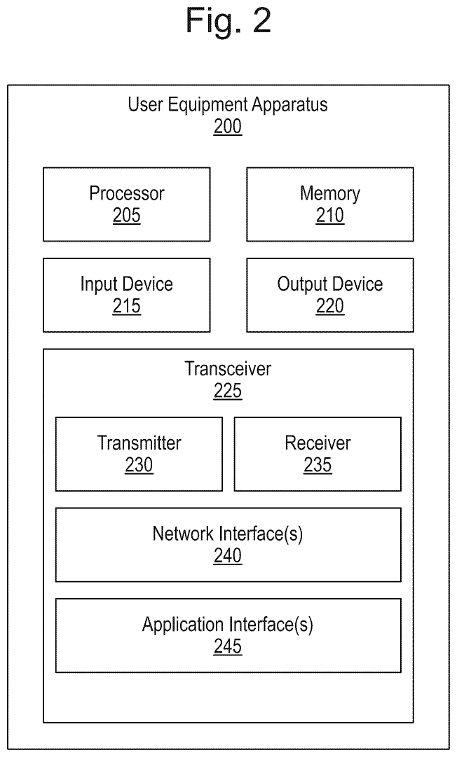

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may comprise a UE 102 or a UE performing the steps 1100 or 1200, for instance. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communication network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

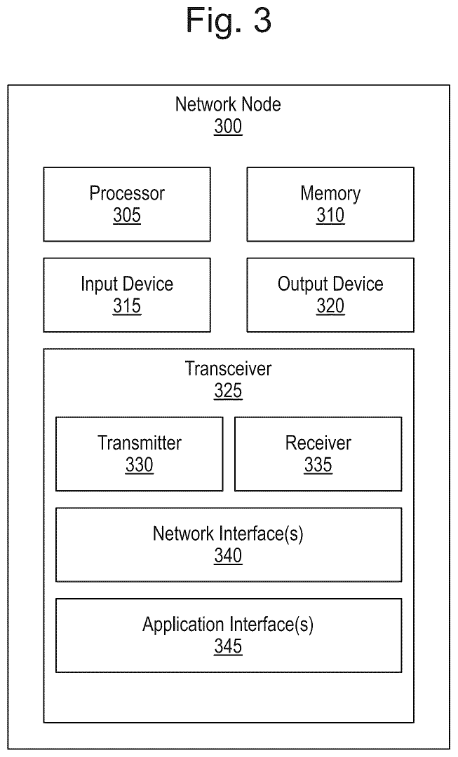

FIG. 3 depicts further details of the network node 300 that may be used for implementing the methods described herein. The network node 300 may be one implementation of an entity in the wireless communication network, e.g. in one or more of the wireless communication networks described herein. The network node 300 may comprise a network node performing the steps 1100 or 1200, for instance. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

There exists certain standardized real-time suited transport architectures and protocols such as the Real-time Transport Protocol (RTP), defined in IETF standard RFC 3550 titled “RTP: A Transport Protocol for Real-Time Applications”, its securely provisioned Secure Real-time Transport Protocol (SRTP) defined in IETF standard RFC 3711 titled “The Secure Real-time Transport Protocol (SRTP)”, and its web-targeted stack Web Real-Time Communications WebRTC defined in the W3C standard recommendation dated 6 Mar. 2023 titled “WebRTC: Real-Time Communication in Browsers”, respectively.

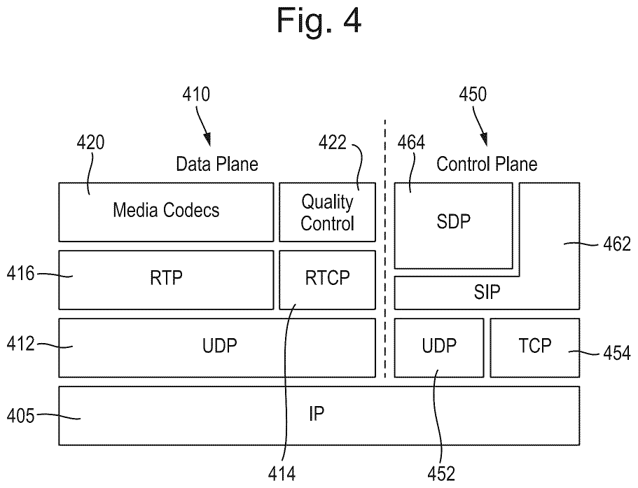

RTP is a media codec agnostic network protocol with application-layer framing used to deliver multimedia (e.g., audio, video etc.) data in real-time over IP networks. It is used in conjunction with a sister protocol for control, i.e., Real-time Transport Control Protocol (RTCP), to provide end-to-end features such as jitter compensation, packet loss and out-of-order delivery detection, synchronization and source streams multiplexing. FIG. 4 illustrates an overview of the RTP and RTCP protocol stack. An IP layer 405 carries signaling from the media session data plane 410 and from the media session control plane 450. The data plane 410 stack comprises functions for a User Datagram Protocol (UDP) 412, RTP 416, RTCP 414, Media codecs 420 and quality control 422. The control plane 450 stack comprises functions for UDP 452, Transmission Control Protocol (TCP) 454, Session Initiation Protocol (SIP) 462 and Session Description Protocol (SDP) 464.

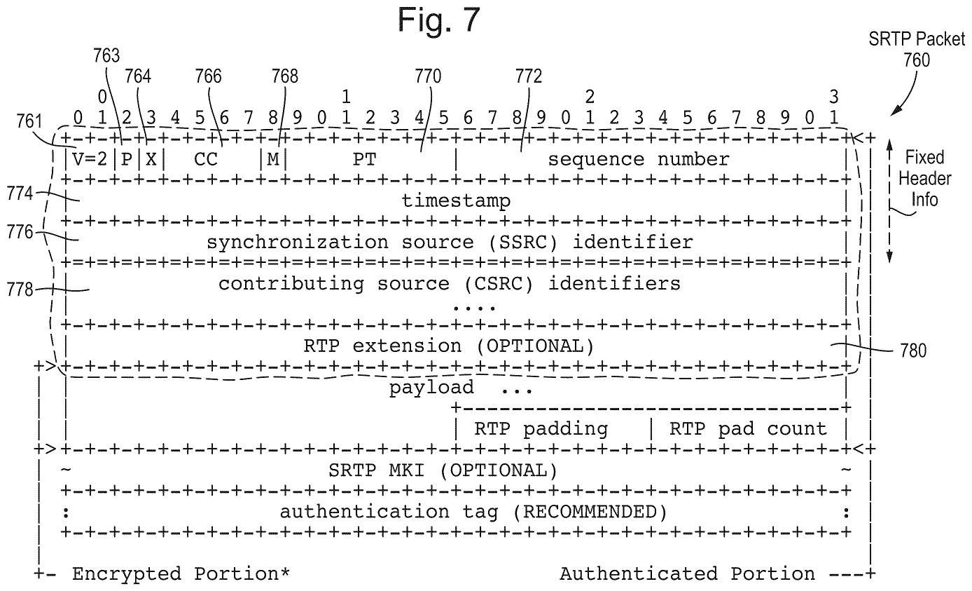

SRTP is a secured version of RTP, providing encryption (mainly by means of payload confidentiality), message authentication and integrity protection (by means of PDU, i.e., headers and payload, signing), as well as replay attack protection. Similarly to RTP, the SRTP sister protocol is SRTCP. This provides the same functions to its RTCP counterpart. As such, in vanilla SRTP versions, the RTP header information is still accessible but non-modifiable, whereas the payload is encrypted. These security provisions are illustrated in FIG. 7. Furthermore, the key exchange and additional security parameters necessary to use SRTP are based upon the Datagram Transport Layer Security (DTLS) key exchange procedure. SRTP is used for these reasons as the transport protocol for media in the WebRTC stack which ensures secure RTC multimedia communications over web browser interfaces.

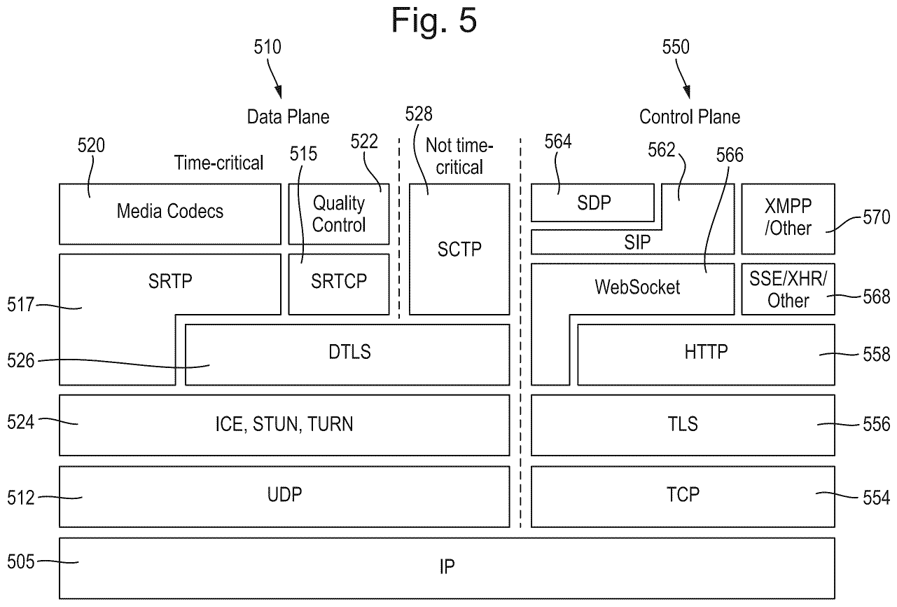

FIG. 5 illustrates an overview of a WebRTC (i.e., based on SRTP) protocol stack. As illustrated, an IP layer 505 carries signaling from the data plane 510 and the control plane 550. The data plane 510 stack comprises functions for UDP 512, Interactive Connectivity Establishment (ICE) 524, Datagram Transport Layer Security (DTLS) 526, SRTP 517, SRTCP 515, media codecs 520, Quality Control 522 and SCTP 528. ICE 574 may use the Session Traversal Utilities for NAT (STUN) protocol and Traversal Using Relays around NAT (TURN) to address real-time media content delivery across heterogeneous networks and NAT rules and firewalls. The SCTP 528 data plane is mainly dedicated as an application data channel and may be non-time critical, whereas the SRTP 517 based stack including elements of control, i.e., SRTCP 515, encoding, i.e., media codecs 520, and Quality of Service (QoS), i.e., Quality Control 522, is dedicated to time-critical transport. The control plane 550 is shown as comprising TCP 554, TLS 556, HTTP 558, SSE/XHR/other 568, XMPP/other 570, SDP 564, and SIP 562.

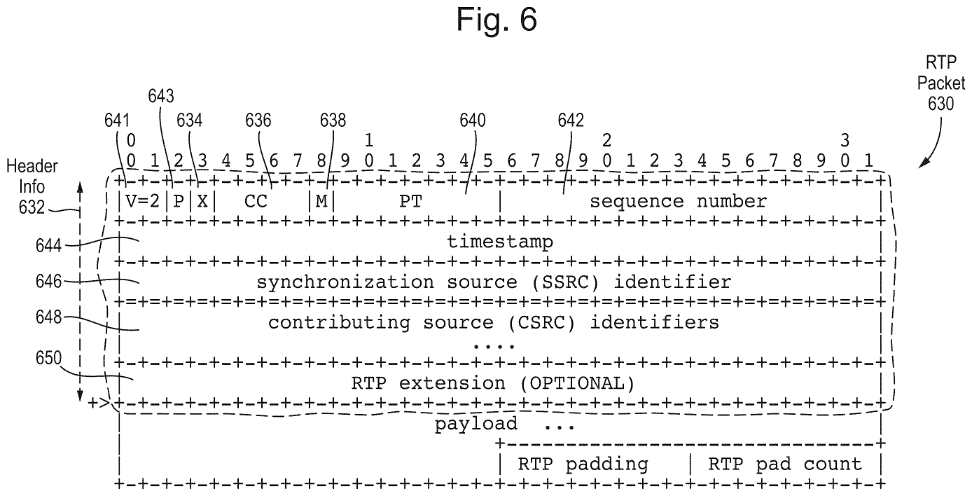

The RTP and SRTP header information share the same format as illustrated, respectively, in FIGS. 6 and 7. FIG. 6 illustrates an RTP packet 630, whereas FIG. 7 illustrates an SRTP packet 760. A brief summary of the fixed header information of packets 630 and 760 will now be provided.

‘V’ 641, 761 is 2 bits indicating the protocol version used.

‘P’—643, 763 is a 1 bit field indicating that one or more zero-padded octets at the end of the payload are present, whereby, among others, the padding may be necessary for fixed-sized encrypted blocks or for carrying multiple RTP/SRTP packets over lower layer protocols.

‘X’ 634, 764 is 1 bit indicating that the standard fixed RTP/SRTP header will be followed by an RTP header extension usually associated with a particular data/profile that will carry more information about the data (e.g., the frame marking RTP header extension for video data, as described in the IETF working draft dated November 2021 titled “Frame Marking RTP Header Extension”, or generic RTP header extensions such as the RTP/SRTP extended protocol, as described in IETF standard RFC 6904 titled “Encryption of Header Extensions in the Secure Real-time Transport Protocol (SRTP)”.)

‘CC’ 636, 766, is 4 bits indicating number of contributing media sources (CSRC) that follow the fixed header.

‘M’ 638, 768 is 1 bit intended to mark information frame boundaries in the packet stream, whose behaviour is exactly specified by RTP profiles (e.g., H.264, H.265, H.266, AV1 etc.).

‘PT’ 640, 770 is 7 bits indicating the payload type, which in case of audio and video codec profiles may be dynamic and negotiated by means of SDP (e.g., 96 for H.264, 97 for H.265, 98 for AV1 etc.). The payload profiles are registered with IANA and rely on IETF profiles describing how the transmission of data is enclosed within the payload of an RTP PDU. Current IANA registered payload profiles, as specified for example in ITU-T standard H.265 V8 (August 2021), describe audio/video codecs and application-based forward-error correction (FEC) coded media content, yet none cater for uncoded non audio-visual data formats.

‘Sequence number’ 642, 772 is 16 bits indicating the sequence number which increments by one with each RTP data packet sent over a session.

‘Timestamp’ 644, 774 is 32 bits indicating timestamp in ticks of the payload type clock reflecting the sampling instant of the first octet of the RTP data packet (associated for video stream with a video frame), whereas the first timestamp of the first RTP packet is selected at random.

‘Synchronization Source (SSRC) identifier’ 646, 776 is 32 bits field indicating a random identifier for the source of a stream of RTP packets forming a part of the same timing and sequence number space, such that a receiver may group packets based on synchronization source for playback.

‘Contributing Source (CSRC) identifier’ 648, 778 list of up to 16 CSRC items of 32 bits each given the amount of CSRC mixed by RTP mixers within the current payload as signalled by the CC bits. The list identifies the contributing sources for the payload contained in this packet given the SSRC identifiers of the contributing sources.

A brief summary of remaining aspects of the complete header information of packets 630 and 760 will now be described.

‘RTP header extension’ 650, 780 is a variable length field present if the X bit 634, 764 is marked. The header extension is appended to the RTP fixed header information after the CSRC list 648, 778 if present. The RTP header extension 650, 780 is 32-bit aligned and formed of the following fields: A 16-bit extension identifier defined by a profile and usually negotiated and determined via the Session Description Protocol (SDP) signaling mechanism; a 16-bit length field describing the extension header length in 32-bits multiples excluding the first 32 bits corresponding to the 16 bits extension identifier and the 16 bits length fields itself; and a 32-bit aligned header extension raw data field formatted according to some RTP header extension identifier specified format.

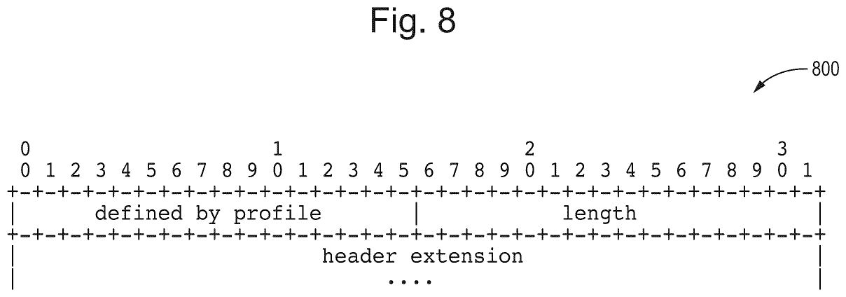

The RTP header extension 650, 780 format and syntax are like the ones of SRTP. The format 800 and syntax is illustrated in FIG. 8. In addition, in both RTP and SRTP only one RTP extension header 650, 780 may be appended to the fixed header information, as described in IETF standard RFC 3550 titled “RTP: A Transport Protocol for Real-Time Applications”. However, for both RTP and SRTP, extensions to the base protocols exist to allow for multiple RTP header extensions 650, 780 of predetermined types to be appended to the fixed header information of the protocols, as per IETF standard RFC: 8285 titled “A General Mechanism for RTP Header Extensions”.

In some embodiments, RTP header extensions produced at the source may be ignored by the destination endpoints that do not have the knowledge to interpret and process the RTP header extensions transmitted by the source endpoint.

Video coding domain and metadata support will now be briefly described, beginning with modern hybrid video coding.

The interactivity and immersiveness of modern and future multimedia XR applications requires guarantees in terms of meeting packet error rate (PER) and packet delay budget (PDB) for the QoE. The video source jitter and wireless channel stochastic characteristics of mobile communications systems make the former challenging to meet especially for high-rate specific digital video transmissions, e.g., 4K, 3D video, 2×2K eye-buffered video etc.

The current video source information is encoded based on 2D, 2D+Depth, or alternatively, 3D representations of video content. The encoded elementary stream video content is generally, regardless of the source encoder, organized into two abstraction layers meant to separate the storage and video coding domains, i.e., the network transport packetization and format, and respectively, the video coding related syntax and associated semantics of a codec. The first determines the bitstream format, whereas the latter specifies the contents of the video coded bitstream.

In one example, MPEG video codec families (e.g., H.264, H.265, H.266) rely on network abstraction layer (NAL) units to packetize and store bitstreams to a byte-aligned format for transport or storage over various mediums (including networks). The NAL units (NALUs) may enclose both video coding layer (VCL) information, i.e., video coded content (e.g., frames, slices, tiles etc.) NALUs, and respectively, non-VCL information, i.e., parameter sets, supplemental enhancement information (SEI) messages etc., The NAL syntax encapsulates thus VCL and non-VCL information and provides abstract containerization mechanisms for in-transit coded streams, i.e., for disk storage/caching/transmission and parsing/decoding.

In another example, open-source video codec alternatives (e.g., VP8/VP9, or similarly, AV1) take a similar approach as MPEG video codecs for packetization, storage and communication over various media. For example, the AV1 bitstream is comprised of Open Bitstream Units (OBUs) and each OBU may contain one or more video coded frames, video coded tiles, non-video coded padding and non-video coded metadata as OBU_METADATA.

Based on the above, the NALUs, or alternatively, OBUs provide mechanisms that can be exploited towards the transport of metadata which is not relevant to the video coded bitstream chroma and luminance representation.

On the other hand, the VCL, or alternatively, the video coded information, encapsulates the video coding procedures of an encoder and compresses the source encoded video information based on some entropy coding method, e.g., context-adaptive binary arithmetic encoding (CABAC), context-adaptive variable-length coding (CAVLC) etc.

A simplified description of the VCL procedures to generically encode video content will now be described. A picture in a video sequence is partitioned into coding units (e.g., macroblocks, coding tree units, blocks, or variations thereof) of a configured size. The coding units may be subsequently split under some tree partitioning structures, or alike hierarchical structures, as described in ITU-T standard H.264 V8 (August 2021), ITU-T standard H.265 V8 (August 2021), ITU-T standard H.266 V4 (April 2022). For instance such tree partitioning structures may comprise binary/ternary/quaternary trees, or under some predetermined geometrically motivated 2D segmentation patterns as described by de Rivaz, p & Haughton, (2018) in the paper titled “AV1 Bitstream & Decoding Process Specification” from the Alliance for Open Media, 182, e.g., the 10-way split.

Encoders use visual references among such coding units to encode picture content in a differential manner based on residuals. The residuals are determined given the prediction modes associated with the reconstruction of information. Two modes of prediction are universally available as intra-prediction (shortly referred to as intra as well) or inter-prediction (or inter in short form). The intra mode is based on deriving and predicting residuals based on other coding units' contents within the current picture, i.e., by computing residuals of current coding units given their adjacent coding units coded content. The inter mode is based, on the other hand, on deriving and predicting residuals based on coding units' contents from other pictures, i.e., by computing residuals of current coding units given their adjacent coded pictures content.

The residuals are then further transformed for compression using some multi-dimensional (2D/3D) spatial multimodal transform, e.g., frequency-based (i.e., Discrete Cosine Transform, or alike), or wavelet-based linear transform (e.g., Walsh Hadamard Transform, or equivalently, Discrete Wavelet Transform), to extract the most prominent frequency components of the coding units' residuals. The insignificant high-frequency contributions of residuals are dropped, and the floating-point transformed representation of remaining residuals is further quantized based on some parametric quantization procedure down to a selected number of bits per sample, e.g., 8/10/12 bits. Lastly, the transformed and quantized residuals and their associated motion vectors to their prediction references either in intra or inter mode are encoded using an entropy encoding mechanism to compress the information based on the stochastic distribution of the source bit content. The output of this operation is a bitstream of the coded residual content of the VCL.

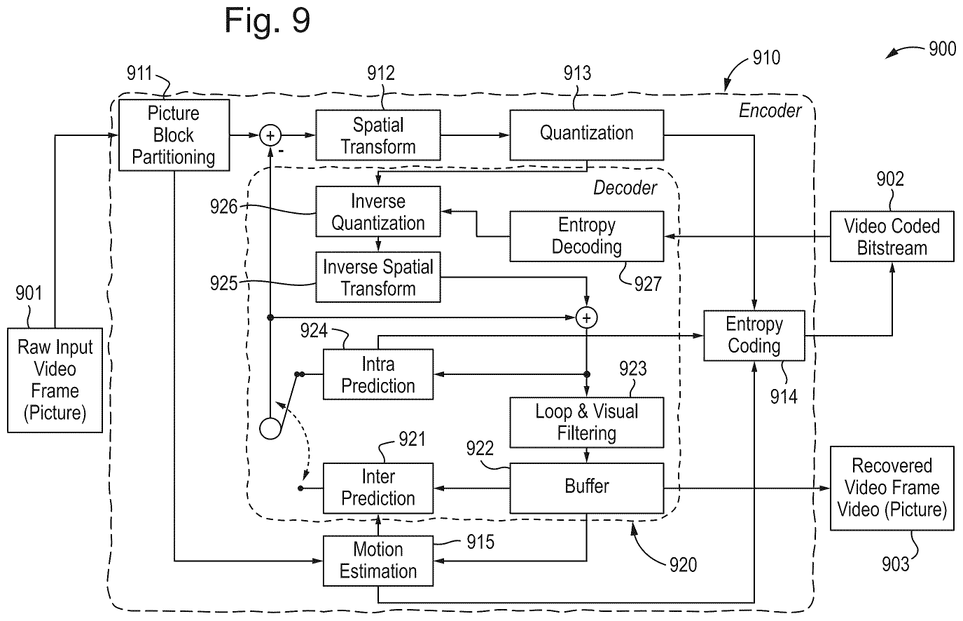

A simplified generic diagram of the blocks of a modern hybrid (applying both temporal and spatial compression via intra-/inter-prediction) video codec is illustrated in FIG. 9.

FIG. 9 illustrates a simplified block diagram 900 of a generic video codec performing both spatial and temporal (motion) compression of a video source. The encoder blocks are captured within the “Encoder” tagged domain 910. The decoder blocks are captured within the “Decoder” tagged domain 920. One skilled in the art may associate the generic diagram from above describing a hybrid codec with a plethora of state-of-the-art video codecs, such as, but not limited to H.264, H.265, H.266 (generically referred to as H.26x) or VP8/VP9/AV1. As such, the concepts hereby utilized shall be considered in general sense, unless otherwise specifically clarified and reduced in scope to some codec embodiment hereafter.

The block diagram 900 shows a raw input video frame (picture) 901 being input to a picture block partitioning function block 911 of encoder 910. A subsequent functional block 912 is illustrated as ‘spatial transform’. A subsequent functional block 913 is illustrated as ‘quantization’. A subsequent functional block 914 is illustrated as ‘entropy coding’. This functional block 914 outputs to video coded bitstream 902 but also to motion estimation 915 of the encoder 910. The motion estimation 915 outputs to inter prediction block 921 of decoder 920. This block 921 outputs to buffer 920, which itself outputs to recovered video frame video (picture) 903. Inter prediction block 921 may be switched to connect with a sum junction feeding into spatial transform 912. Further, it is illustrated in the block diagram 900 that quantization block 913 may output to an inverse quantization block 926 of decoder 920. The inverse quantization block 926 illustrated as receiving entropy decoding 927 of video coded bitstream 902. The inverse quantization block 926 outputs to inverse spatial transform block 925 which, via a sum junction, feeds into a loop & visual filtering block 923, itself feeding into buffer 922. As hereinbefore described, the block diagram 900 is illustrated by way of example, to convey the various functional blocks of a modern hybrid video codec from the perspective of both encoder and decoder operations.

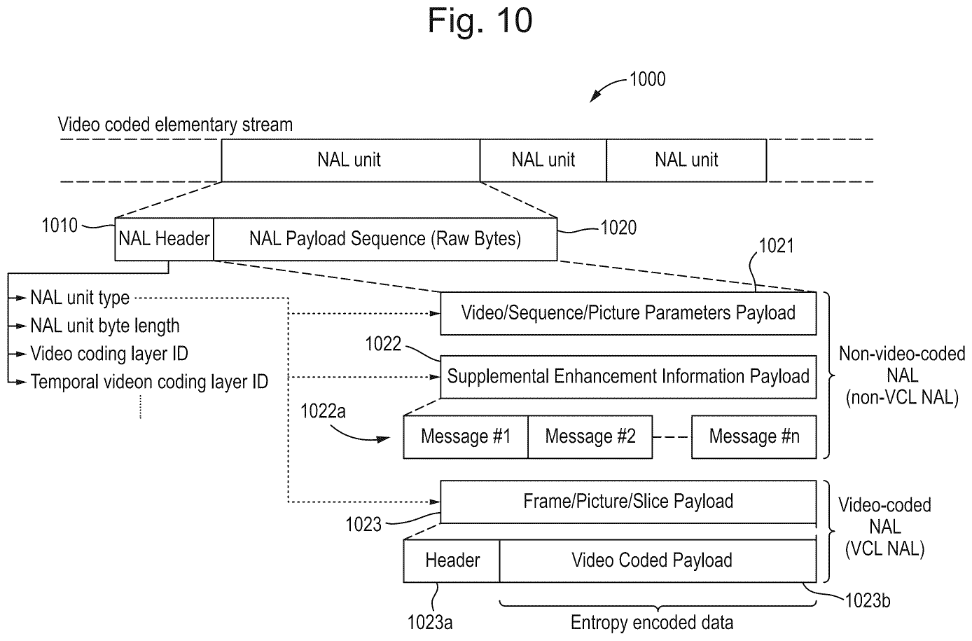

The coded residual bitstream 902 is thus encapsulated into an elementary stream as NAL units, or equivalently, as OBUs ready for storage or transmission over a network. The NAL units, or alternatively, OBUs are the main syntax elements of a video codec, and these may encapsulate encoded video parameters (e.g., video/sequence/picture parameter set (VPS/SPS/PPS)), one or more supplemental enhancement information (SEI) messages, or alternatively OBU metadata payloads, and encoded video headers and residuals data, (e.g., slices as partitions of a picture, or equivalently, a video frame or video tile). The encapsulation general syntax carries information described by codec specific semantics meant to determine the usage of metadata, non-video coded data and video encoded data and aid the decoding process. Within one example referencing the MPEG video codec family (e.g., H.264, H.265, H.266), the NAL units encapsulation syntax is composed of a header portion determining the beginning of a NAL unit and the type thereof, and a raw byte payload sequence containing the NAL unit relevant information. The NAL unit payload may subsequently be formed of a payload syntax or a payload specific header and an associated payload specific syntax. A critical subset of NAL units is formed of parameter sets, e.g., VPS, SPS, PPS, SEI messages and configuration NAL units (also known generically as non-VCL NAL units), and picture slice NAL units containing video encoded data (e.g., entropy-based arithmetic encoding) as VCL information. These concepts are illustrated in FIG. 10 for the context of an elementary stream applicable generically to the H.264, H.265, H.266 MPEG family of video codecs.

FIG. 10 illustrates a video coded elementary stream and its corresponding plurality of NAL units 1000. The NAL units 1000 are formed of a header 1010 and a payload 1020. The header 1010 contains information about the type, size, and video coding attributes and parameters of the NAL unit data payload 1020 enclosed information. The NAL unit data may be non-VCL NAL comprising video/sequence/picture parameters payload 1021, and supplemental enhancement information payload 1022, or VCL NAL comprising a frame/picture/slice payload 1023 having header 1023a and video coded payload 1023b. The non-VCL NALUs may include in a supplemental enhancement information payload 1022 one or more SEI messages 1022a. The NAL header 1010 is illustrated as comprising a NAL unit type, NAL unit byte length, video coding layer ID and temporal video coding layer ID.

Consequently, a decoder implementation may implement a bitstream parser extracting the necessary metadata information and VCL associated metadata from the NAL unit sequence 1000; decode the VCL residual coded data sequence to its transformed and quantized values; apply the inverse linear transform and recover the residual significant content; perform intra or inter prediction to reconstruct each coding unit luminance and chromatic representation; apply additional filtering and error concealment procedures; reproduce the raw picture sequence representation as video playback.

These operations and procedures may happen successively, as listed, or in parallel depending on a decoder specific implementation. One skilled in the art should recognize that similar high-level operations are applicable to other family of video codecs, such as for instance AV1 codec.

To aid the disclosure herein, metadata support in video codecs will now be briefly described.

Modern video codecs, e.g., H.264, H.265, AV1, or alternatively, H.266, provide byte-aligned transport mechanisms for metadata within the video coded elementary stream, or alternatively, bitstream. Such non-video coded data is alternatively referred to in a video coding context as metadata since the comprised information is not related to alter the luma or chroma of the decoded frame, or alternatively, picture. This metadata is encapsulated as well into NALUs as SEI messages for H.26x MPEG family of codecs and in OBUs as OBU metadata for AV1.

In case of each codec the metadata may have different types associated with different syntax and semantics specified additionally in the codec specifications, e.g., (ITU-T standard H.264 (August 2021), ITU-T standard H.265 V8 (August 2021), ITU-T standard H.266 V4 (April 2022), Rivaz, p & Haughton, (2018) in the paper titled “AV1 Bitstream & Decoding Process Specification” from the Alliance for Open Media, 182), or alternatively, in ITU specifications of metadata types such as for instance in ITU-T Series H specification V8 (April 2020) titled “Series H: Audiovisual and Multimedia Systems, Infrastructure of audiovisual services-coding of moving video: versatile supplemental enhancement information messages for coded video bitstreams”, or ITU-T Recommendation T.35, titled “Terminal provider codes notification form: available information regarding the identification of national authorities for the assignment of ITU-T recommendation T.35 terminal provider codes”. Nevertheless, in none of the specifications the user data SEI message, or alternatively, OBU metadata user private data format is specified. Furthermore, all the herein discussed video codecs and their associated encoders and decoders allow the exposure via dedicated interfaces of the user data metadata type to the application layer by passthrough of either NALUs SEI messages, or alternatively, OBUs carrying OBU metadata to the application layer.

In current WebRTC specification the supported and mandatory video media codecs are AVC/H.264 with its constrained baseline profile and VP8, with additional optional support for VP9. Given the increasing support of AV1 and H.265 in the main browser engines (e.g., Chromium as used by Google Chrome and Microsoft Edge, or alternatively, Mozilla as used by Mozilla Firefox), it is expected that WebRTC specification will soon evolve to additionally include AV1 support, and potentially also optional support for a restrained profile of H.265. On the other hand, in 3GPP up to Release 18, H.264 and H.265 are the default video codecs specified and supported, whereas support for H.266 and AV1 is considered for further study for the next releases.

This disclosure leverages these facts regarding user data metadata and video codecs support to the benefit of proposing a new real-time, in-band transport mechanism for interaction and immersion metadata associated with XR applications and their video streams.

The solution of this disclosure proposes the transport of interaction and immersion metadata associated with an XR application as part of the byte-aligned format of a video coded bitstream. This is based on encapsulating interaction and immersion metadata as user data type of metadata in-band into the video coded elementary stream. To this end, the NALU SEI message of user data type (e.g., in case of MPEG H.264, H.265, H.266), or alternatively, the OBU metadata of user data type (e.g., in case of AV1) is used to encapsulate the interaction and immersion metadata of the application. The resulted encapsulation of the interaction and immersion metadata is in turn transported in-band with an associated video stream, whereby any of RTP/SRTP, or alternatively, WebRTC or alike real-time transport protocol stacks can be used to transfer the video stream and interaction and immersion metadata over any IP-based network.

The solution proposed is enabled by the traffic characteristics of XR applications. The traffic of XR applications relies in general on multimodal flows carrying different data modalities (e.g., video, audio, pose information, user action/interaction information, immersion information) which are related by the interactive and immersive nature of the XR application. As such, these multimodal flows are transported in parallel both in UL and DL directions for AR, or alternatively, VR applications. Furthermore, in many embodiments, the interaction and immersion data collected by an XR runtime on a device, or alternatively, served by an Application Server/Edge Application Server in a split-rendering XR scenario is directly associated with video flows of an XR application traffic. To this end, the interaction and immersion metadata is used to increase the QoE and perception of immersiveness and interactivity of an XR application by adapting and optimizing the processing of other multimedia streams, namely video, audio, or even haptics. This requires in effect, inter-flow synchronization, jitter compensation and reliable transport mechanisms which is provided by the solution proposed herein.

The disclosure herein provides an apparatus for wireless communication in a wireless communication system, comprising: a processor; and a memory coupled with the processor, the processor configured to cause the apparatus to: generate, using one or more media sources, one or more data units of multimedia immersion and interaction data; encode, using a video codec, an encoded video stream, the encoded video stream comprising as non-video coded embedded metadata, the one or more data units of multimedia immersion and interaction data; and transmit, using a real-time transport protocol, the encoded video stream.

In some embodiments, the processor is configured to cause the apparatus to generate the non-video coded embedded metadata to comprise: a first field comprising an identifier for a syntax and semantics representation format of the one or more data units of multimedia immersion and interaction data; and a second field comprising the one or more data units of multimedia immersion and interaction data, encoded according to the syntax and semantics representation format corresponding to the identifier of the first field.

In some embodiments the identifier is a universally unique identifier ‘UUID’ indication.

In some embodiments the UUID is unique to a specific application or session, or the UUID is globally unique. For instance the UUID may be compliant with ISO-IEC-11578 ANNEX A format and syntax. The term ‘session’ refers to a temporary and interactive, i.e., updatable, set of configurations and rules, e.g., media formats and codecs, network configuration, determining the exchange of information, including media content, between two or more endpoints connected over a network.

In some embodiments the video codec comprises in part a video codec selected from the list of video codecs consisting of: H.264 video codec specification; H.265 video codec specification; H.266 video codec specification; and AV1 video codec specification. Certain other video codec specifications relying in part on said specification may also apply, e.g., OMAF, V-PCC or alike. OMAF encodes omnidirectional video content and it comprises at least one video stream encoded with AVC and HEVC, V-PCC encodes 2D projected 3D video and it comprises a video stream encoding the projected 2D flat frames by means of AVC and HEVC, for instance.

In some embodiments the video codec comprises the H.264, H.265, or H.266 codecs, and the processor is configured to cause the apparatus to encode the encoded video stream, by causing the apparatus to encapsulate the non-video coded embedded metadata as a payload of user data in one or more supplemental enhancement information ‘SEI’ messages of the type ‘user data unregistered’; and/or the video codec comprises the AV1 codec, and the processor is configured to cause the apparatus to encode the encoded video stream, by causing the apparatus to encapsulate the non-video coded embedded metadata as a payload of user data in one or more metadata open bitstream units ‘OBUs’ of type ‘unregistered user private data’. Where an SEI message is used, the payload type may be ‘5’. The SEI message may be is prefixed or suffixed to a NALU, for instance. Where an OBU is used, the OBU metadata_type may equal ‘X’, where X can be any of 6-31.

In some embodiments, the real-time transport protocol comprises a transport protocol selected from the list of transport protocols consisting of: real-time protocol ‘RTP’; secure real-time protocol ‘SRTP’; and web real-time communications ‘WebRTC’.

In some embodiments the real-time transport protocol comprises encryption and/or authentication.

The processor may, in some embodiments, be configured to cause the apparatus to generate the one or more data units of multimedia immersion and interaction data, by causing the apparatus to sample the one or more media sources.

In some embodiments, the one or more media sources comprise peripherals selected from the list of peripherals consisting of: one or more physical dedicated controllers; one or more red green blue ‘RGB’ cameras; one or more RGB-depth ‘RGBD’ cameras; one or more infrared ‘IR’ cameras; one or more microphones; and one or more haptic transducers.

In some embodiments the one or more data units of multimedia immersion and interaction data comprises immersion and interaction data selected from the list consisting of: a user viewpoint data; a user field of view data; a user pose/orientation data; a user gesture tracking data; a user body tracking data; a user facial feature tracking data; a user action and/or user input data; a split rendering pose and spatial information; and an augmented reality object representation, comprising of at least one of a graphical description of an object and an object positional anchor.

The one or more data units of multimedia immersion and interaction data may in some embodiments, comprise extended reality ‘XR’ multimedia immersion and interaction data.

In some embodiments the apparatus comprises a video encoder for generating, using the video codec, the encoded video stream; and a logic interface for controlling the video encoder. The video encoder/interface may be based on an API as an encoder library or may be based on a hardware abstraction layer middleware.

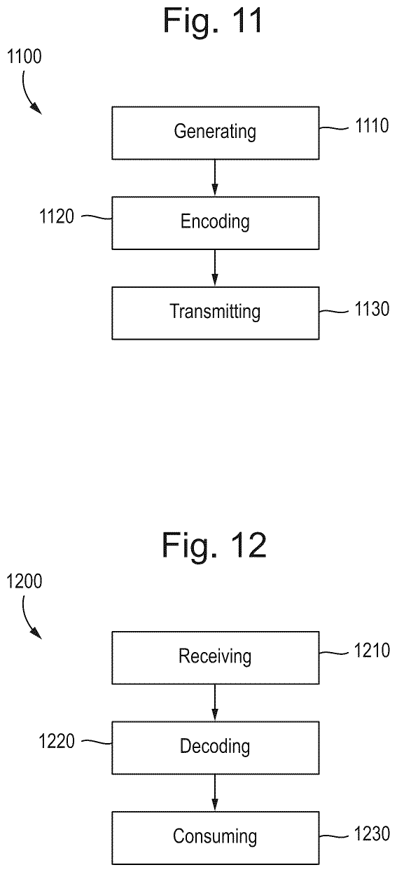

FIG. 11 illustrates an embodiment 1100 of a method of wireless communication in a wireless communication system.

A first step 1110 comprises generating, using one or more media sources, one or more data units of multimedia immersion and interaction data;

A further step 1120 comprises encoding, using a video codec, an encoded video stream, the encoded video stream comprising as non-video coded embedded metadata, the one or more data units of multimedia immersion and interaction data.

A further step 1130 comprises transmitting, using a real-time transport protocol, the encoded video stream.

In certain embodiments, the method 1100 may be performed by a processor executing program code, for example, a microcontroller, a microprocessor, a CPU, a GPU, an auxiliary processing unit, a FPGA, or the like.

Some embodiments comprise generating the non-video coded embedded metadata to comprise: a first field comprising an identifier for a syntax and semantics representation format of the one or more data units of multimedia immersion and interaction data; and a second field comprising the one or more data units of multimedia immersion and interaction data, encoded according to the syntax and semantics representation format corresponding to the identifier of the first field.

In some embodiments the identifier is a universally unique identifier ‘UUID’ indication.

In some embodiment the UUID is unique to a specific application or session, or the UUID is globally unique. The UUID may for instance be compliant with ISO-IEC-11578 ANNEX A format and syntax.

In some embodiments the video codec comprises in part a video codec selected from the list of video codecs consisting of: H.264 video codec specification; H.265 video codec specification; H.266 video codec specification; and AV1 video codec specification. Some other video codec specifications relying in part on said specification may also apply, e.g., OMAF, V-PCC or alike. OMAF encodes omnidirectional video content and it comprises at least one video stream encoded with AVC and HEVC, V-PCC encodes 2D projected 3D video and it comprises a video stream encoding the projected 2D flat frames by means of AVC and HEVC.

In some embodiments the video codec comprises the H.264, H.265, or H.266 codecs, and the encoding comprises encapsulating the non-video coded embedded metadata as a payload of user data in one or more supplemental enhancement information ‘SEI’ messages of the type ‘user data unregistered’; and/or the video codec comprises the AV1 codec, and the encoding comprises encapsulating the non-video coded embedded metadata as a payload of user data in one or more metadata open bitstream units ‘OBUs’ of type ‘unregistered user private data’. Where an SEI message is used, the payload type may be ‘5’. The SEI message may be prefixed or suffixed to a NALU, for instance. Where an OBU is used, the OBU metadata_type may be ‘X’, where X can be any of 6-31.

In some embodiments, the real-time transport protocol comprises a transport protocol selected from the list of transport protocols consisting of: real-time protocol ‘RTP’; secure real-time protocol ‘SRTP’; and web real-time communications ‘WebRTC’.

In some embodiments the real-time transport protocol comprises encryption and/or authentication.

Some embodiments comprise generating the one or more data units of multimedia immersion and interaction data, by causing the apparatus to sample the one or more media sources.

In some embodiments, the one or more media sources comprise peripherals selected from the list of peripherals consisting of: one or more physical dedicated controllers; one or more red green blue ‘RGB’ cameras; one or more RGB-depth ‘RGBD’ cameras; one or more infrared ‘IR’ cameras; one or more microphones; and one or more haptic transducers.

In some embodiments, the one or more data units of multimedia immersion and interaction data comprises immersion and interaction data selected from the list consisting of: a user viewpoint data; a user field of view data; a user pose/orientation data; a user gesture tracking data; a user body tracking data; a user facial feature tracking data; a user action and/or user input data; a split rendering pose and spatial information; and an augmented reality object representation, comprising of at least one of a graphical description of an object and an object positional anchor.

In some embodiments, the one or more data units of multimedia immersion and interaction data comprises extended reality ‘XR’ multimedia immersion and interaction data.

Some embodiments comprise using/controlling a video encoder for generating, using the video codec, the encoded video stream; and using a logic interface for controlling the video encoder. The video encoder/interface may be based on an API as an encoder library or is based on a hardware abstraction layer middleware.

The disclosure herein further provides an apparatus for wireless communication in a wireless communication system, comprising: a processor; and a memory coupled with the processor, the processor configured to cause the apparatus to: receive, using a real-time transport protocol, an encoded video stream, the encoded video stream being encoded using a video codec, wherein the encoded video stream comprises as non-video coded embedded metadata, one or more data units of multimedia immersion and interaction data generated by one or more media sources; decode, using the video codec, the encoded video stream, wherein the decoding comprises extracting the non-video coded embedded metadata; and consume, from the non-video coded embedded metadata, the one or more data units of multimedia immersion and interaction data.

In some embodiments the non-video coded embedded metadata comprises: a first field comprising an identifier for a syntax and semantics representation format of the one or more data units of multimedia immersion and interaction data; and a second field comprising the one or more data units of multimedia immersion and interaction data, encoded according to the syntax and semantics representation format corresponding to the identifier of the first field.

In some embodiments, the identifier is a universally unique identifier ‘UUID’ indication.

In some embodiments, the UUID is unique to a specific application or session, or the UUID is globally unique. The UUID may be compliant with ISO-IEC-11578 ANNEX A format and syntax, for instance.

In some embodiments, the video codec comprises in part a video codec selected from the list of video codecs consisting of: H.264 video codec specification; H.265 video codec specification; H.266 video codec specification; and AV1 video codec specification. Some other video codec specifications relying in part on said specification may also apply, e.g., OMAF, V-PCC or alike. OMAF encodes omnidirectional video content and it comprises at least one video stream encoded with AVC and HEVC, V-PCC encodes 2D projected 3D video and it comprises a video stream encoding the projected 2D flat frames by means of AVC and HEVC.

In some embodiments the video codec comprises the H.264, H.265, or H.266 codecs, and the non-video coded embedded metadata is encapsulated in the encoded video stream as a payload of user data in one or more supplemental enhancement information ‘SEI’ messages of the type ‘user data unregistered’; and/or the video codec comprises the AV1 codec, and the non-video coded embedded metadata is encapsulated in the encoded video stream as a payload of user data in one or more metadata open bitstream units ‘OBUs’ of type ‘unregistered user private data’. Where an SEI message is used, the payload type may be 5. The SEI message may be prefixed or suffixed to a NALU. Where an OBU is used, the metadata_type may be X, where X can be any of 6-31.

In some embodiments the real-time transport protocol comprises a transport protocol selected from the list of transport protocols consisting of: real-time protocol ‘RTP’; secure real-time protocol ‘SRTP’; and web real-time communications ‘WebRTC’.

In some embodiments, the real-time transport protocol comprises encryption and/or authentication.

In some embodiments, the one or more media sources comprise peripherals selected from the list of peripherals consisting of: one or more physical dedicated controllers; one or more red green blue ‘RGB’ cameras; one or more RGB-depth ‘RGBD’ cameras; one or more infrared ‘IR’ cameras; one or more microphones; and one or more haptic transducers.

In some embodiments, the one or more data units of multimedia immersion and interaction data comprises immersion and interaction data selected from the list consisting of: a user viewpoint data; a user field of view data; a user pose/orientation data; a user gesture tracking data; a user body tracking data; a user facial feature tracking data; a user action and/or user input data; a split rendering pose and spatial information; and an augmented reality object representation, comprising of at least one of a graphical description of an object and an object positional anchor.

In some embodiments, the one or more data units of multimedia immersion and interaction data comprises extended reality ‘XR’ multimedia immersion and interaction data.

In some embodiments the apparatus comprises a video decoder for decoding, using the video codec, the encoded video stream; and a logic interface for controlling the video decoder. The video decoder/interface is based on an API as a decoder library or is based on a hardware abstraction layer middleware.

FIG. 12 illustrates an embodiment of a method 1200 for wireless communication in a wireless communication system.

A first step 1210 comprises receiving, using a real-time transport protocol, an encoded video stream, the encoded video stream being encoded using a video codec, wherein the encoded video stream comprises as non-video coded embedded metadata, one or more data units of multimedia immersion and interaction data generated by one or more media sources.

A further step 1220 comprises decoding, using the video codec, the encoded video stream, wherein the decoding comprises extracting the non-video coded embedded metadata.

A further step 1230 comprises consuming, from the non-video coded embedded metadata, the one or more data units of multimedia immersion and interaction data.

In certain embodiments, the method 1200 may be performed by a processor executing program code, for example, a microcontroller, a microprocessor, a CPU, a GPU, an auxiliary processing unit, a FPGA, or the like.

In some embodiments, the non-video coded embedded metadata comprises: a first field comprising an identifier for a syntax and semantics representation format of the one or more data units of multimedia immersion and interaction data; and a second field comprising the one or more data units of multimedia immersion and interaction data, encoded according to the syntax and semantics representation format corresponding to the identifier of the first field.

In some embodiments the identifier is a universally unique identifier ‘UUID’ indication.

In some embodiments the UUID is unique to a specific application or session, or the UUID is globally unique. The UUID may be compliant with ISO-IEC-11578 ANNEX A format and syntax.

In some embodiments the video codec comprises in part a video codec selected from the list of video codecs consisting of: H.264 video codec specification; H.265 video codec specification; H.266 video codec specification; and AV1 video codec specification. Some other video codec specifications relying in part of said specification may also apply, e.g., OMAF, V-PCC or alike. OMAF encodes omnidirectional video content and it comprises at least one video stream encoded with AVC and HEVC, V-PCC encodes 2D projected 3D video and it comprises a video stream encoding the projected 2D flat frames by means of AVC and HEVC.

In some embodiments the video codec comprises the H.264, H.265, or H.266 codecs, and the embedded non-video coded metadata is encapsulated in the encoded video stream as a payload of user data in one or more supplemental enhancement information ‘SEI’ messages of the type ‘user data unregistered’; and/or the video codec comprises the AV1 codec, and the embedded metadata is encapsulated in the encoded video stream as a payload of user data in one or more metadata open bitstream units ‘OBUs’ of type ‘unregistered user private data’. Where SEI messages are used, the payload type may be 5. The SEI message may be prefixed or suffixed to a NALU, for instance. Where an OBU is used, the OBU metadata_type may be ‘X’, where X can be any of 6-31.

In some embodiments, the real-time transport protocol comprises a transport protocol selected from the list of transport protocols consisting of: real-time protocol ‘RTP’; secure real-time protocol ‘SRTP’; and web real-time communications ‘WebRTC’.

The real-time transport protocol may, in some embodiments, comprise encryption and/or authentication.

In some embodiments the one or more media sources comprise peripherals selected from the list of peripherals consisting of: one or more physical dedicated controllers; one or more red green blue ‘RGB’ cameras; one or more RGB-depth ‘RGBD’ cameras; one or more infrared ‘IR’ cameras; one or more microphones; and one or more haptic transducers.

In some embodiments, the one or more data units of multimedia immersion and interaction data comprises immersion and interaction data selected from the list consisting of: a user viewpoint data; a user field of view data; a user pose/orientation data; a user gesture tracking data; a user body tracking data; a user facial feature tracking data; a user action and/or user input data; a split rendering pose and spatial information; and an augmented reality object representation, comprising of at least one of a graphical description of an object and an object positional anchor.

In some embodiments the one or more data units of multimedia immersion and interaction data comprises extended reality ‘XR’ multimedia immersion and interaction data.

Some embodiments comprise using/controlling a video decoder for decoding, using the video codec, the encoded video stream; and using a logic interface for controlling the video decoder. The video encoder/interface may be based on an API as an encoder library or is based on a hardware abstraction layer middleware.

Aspects of embodiments of interaction and immersion user data transport over a video elementary stream as non-video coded embedded metadata, will now be described in greater detail, with reference to a video source of an XR application. In the sequel, the terms interaction and immersion user data, interaction and immersion metadata, non-video coded user data, non-video coded embedded user data, non-video coded embedded metadata, or simply metadata are used to this end interchangeably.

In some embodiments a video source of an XR application may receive over an interface from the application logic one or more data units of immersion and interaction metadata. In some embodiments, the video source may be formed of at least a video encoder and a logic interface to configure, control, or alternatively, program the video encoder functionality. In some embodiments such an interface may be implemented based on an application programming interface (API) as an encoder library. Some examples of such libraries may include libav, x264/openh264, x265/openh265, libaom, libsvtav1 or alike. In another embodiment the interface may be implemented as a hardware abstraction layer (HAL) middleware meant to expose functionality of a HW accelerated video encoder. In the latter, the HW acceleration may be based on a dedicated or general CPU, a GPU, a TPU, or any other compute medium serving accelerated functionality of a video encoder. An example of such an interface may be considered by reference to the NVIDIA® NVENC/NVDEC suite and video toolset for HW-accelerated encoding.

In some embodiments the interface to the video source, or alternatively, the video encoder, may additionally comprise of functionality to allow the ingress of non-video coded data user data as metadata. This functionality may be implemented in some embodiments as part of an API, or alternatively, of a HAL, exposing the user data to the video encoder. In some embodiments, this user data may contain application specific information, related to interaction and immersion support by the application, e.g., an XR application.

In some implementations, the interaction and immersion user data as metadata to the video source may include but not be limited to: user viewport description (i.e., an encoding of azimuth, elevation, tilt, and associated ranges of motion describing the projection of the user view to a target display); user field of view (FoV) indication (i.e., the extent of the visible world from the viewer perspective usually described in angular domain, e.g., radians/degrees, over vertical and horizontal planes); user pose/orientation tracking data (i.e., micro-/nanosecond timestamped 3D vector for position and/or quaternion representation of an XR space describing the user orientation up to 6DoF, for example, as per the OpenXR XrPosef API specification); user gesture tracking data (i.e., an array of one or more hands tracked according to their pose, each hand tracking data consisting of an array of hand joint locations and velocities relative to a base XR space, for example, as per OpenXR OpenXR_EXT_hand_tracking API specification); user body tracking data (e.g., a BioVision Hierarchical (BVH) encoding of the body and body segments movements and associated pose object); user facial expression/eye movement tracking data (e.g., as an array of key points/features positions, pose, or their encoding to pre-determined facial expression classes); user actionable inputs (i.e., user actions and inputs to physical controllers or logic controllers defined within an XR space, for example as per OpenXR XrAction handle capturing diverse user inputs to controllers or HW command units supported by an AR/VR device compliant with OpenXR); split-rendering pose and spatial information (i.e., pose information containing the pose information, spatial information, or alternatively, user actions, used by a split-rendering server to pre-render an XR scene, or alternatively, a scene projection as a video frame); application and AR anchor data and description (i.e., metadata determining the position of an object or a point in the XR space as an anchor for placing virtual 2D/3D objects, such as text renderings, static video content, 2D/3D video content etc.).

In some embodiments, an XR application may sample such interaction and immersion data via device peripherals, such as controller inputs, RGB cameras, RGBD cameras, IR photo sensors, or alike, microphones, haptic transducers. In some examples, the data acquired through sampling may fall into the category of user pose, user tracking data, user action, or alike. In some embodiments, the XR application may generate, or alternatively, process such interaction and immersion metadata based on the application logic, e.g., by means of XR object placement in the FoV of the user, or by means of split-rendering processing. In some examples, the data thus generated may fall into the category of AR/VR 2D flattened, or alternatively, 3D objects and their respective anchors and associated information, of user pose, of user tracking, or alternatively, of user actions associated with split-rendering processing.

In some embodiments, the application uses a video source interface to interact with the video encoder and instruct the later to add to the encoded video stream the application interaction and immersion user data as metadata to the video elementary stream.

In some embodiments, whereby an MPEG H.26x encoder is being used by the application, the interaction and immersion data is passed to the encoder as a payload via the video source interface buffers. The video encoder encapsulates the application payload within a NALU as a SEI message of type user_data_unregistered, with payloadType==5. In one embodiment the SEI message may be prefixed to the video coded NALUs (e.g., H.264 as default and only option, H.265, H.266 based on PREFIX_SEI_NUT NALU type), or alternatively, in another embodiment the SEI message may be suffixed to the video coded NALUs (e.g., H.265 based on SUFFIX_SEI_NUT NALU type). In such embodiments, the exact full syntax of the user_data_unregistered SEI message NALU is not defined by any of the H.26x or H.274 specifications, and the encoder may passthrough, as indicated by the application, the data to a decoder within the video elementary stream generated (e.g., according to H.264, H.265, or alternatively, H.266 specification). However, the MPEG H.26x specifications define a partial syntax and semantics specification of the SEI user_data_unregistered message as per Annex D of ITU-T standard H.264 (April 2021), ITU-T standard H.265 V8 (April 2021), and respectively, as per Clause 8 of ITU-T Recommendation T.35, titled “Terminal provider codes notification form: available information regarding the identification of national authorities for the assignment of ITU-T recommendation T.35 terminal provider codes”. The pseudocode syntax of the SEI user_data_unregistered message is, for completeness, provided below:

```
user_data_unregistered( payloadSize ) {
  uuid_iso_iec_11578
  for( i = 16; i < payloadSize; i++ ) {
    user_data_payload_byte
  }
}
```

It should be noted that the pseudocode syntax comprises the uuid_iso_iec_11578 unsigned integer of 128 bits, which acts as a UUID identifier according to Annex A ISO-IEC-11578 specification for remote procedure calls and the syntax user_data_payload_byte is the byte representation of the of SEI message user data payload. Consequently, in one embodiment the application may uniquely identify various syntaxes and semantics of interaction and immersion metadata based on the 128 bits UUID.

In some embodiments, whereby an AV1 encoder is being used by the application, the interaction and immersion data is passed to the encoder as a payload via the video source interface buffers. The video encoder encapsulates the application payload within an OBU as a metadata_obu of type unregistered user private data according to metadata_type==X, whereby X can be any of 6 to 31. In such an embodiment, an AV1 encoder may passthrough, as indicated by the application, the data to a decoder within the AV1 video elementary stream generated. Furthermore, the exact syntax of metadata_obu is not defined by the AV1 specification and left completely to the application. Again, for completeness the pseudocode is recited below from clause 5.8.1 of de Rivaz, p & Haughton, (2018) in the paper titled “AV1 Bitstream & Decoding Process Specification” from the Alliance for Open Media, 182.:

```
metadata_obu( ) {
  metadata_type
  if ( metadata_type == METADATA_TYPE_ITUT_T35 )
    metadata_itut_t35( )
  else if ( metadata_type == METADATA_TYPE_HDR_CLL )
    metadata_hdr_cll( )
  else if ( metadata_type == METADATA_TYPE_HDR_MDCV )
    metadata_hdr_mdcv( )
  else if ( metadata_type == METADATA_TYPE_SCALABILITY )
    metadata_scalability( )
  else if ( metadata_type == METADATA_TYPE_TIMECODE )
    metadata_timecode( )
```

It should be noted that, the AV1 specification ignores therefore the unregistered user private data and a decoder implementation will not process the data in any way and may simply expose it to an application consumer logic on the decoder side.

In some embodiments an application may additionally use an UUID as a first field of the unregistered user private data to uniquely identify a syntax and semantics associated with the data carried over the metadata OBU. In one embodiment the UUID field may be represented as 16 bytes in compliancy with the ISO-IEC-11578 Annex A specification format, i.e., consist of 32 hexadecimal base-16 digits. The benefit of this solutions represents backwards and cross-compatibility with MPEG series of H.26x video coding standards. In another embodiment the UUID field may represented as a string of 36 characters of 8 bits each, comprising of the 32 hexadecimal characters of the UUID and their corresponding 4 dash, “-”, characters as for example the representation “123e4567-e89b-12d3-a456-426614174000”.

In some embodiments, the video encoder encapsulates, byte-aligns, and embeds therefore the application interaction and immersion user data as part of the encoded video elementary stream. In one example the interaction and immersion user data could be video metadata as a NALU SEI message of user_data_unregistered type for MPEG H.26x family of codecs. Alternatively, in another example the interaction and immersion user data could be video metadata OBU of type unregistered user private for the AV1 video codec.

In some embodiments, the payload of user data may contain at least two fields. In a first embodiment, the first field acts as a unique type identifier, i.e., a UUID, determining the syntax and semantics of the corresponding information payload located in a second field. In a second embodiment, the second field carries the interaction and immersion data, data embedded as metadata into the video coded elementary stream. In a further embodiment, the second field syntax and semantics may be determined at least in part based on the first field. This may imply an indexed search (e.g., in a list of supported formats for interaction and immersion metadata by a particular communication endpoint, like an UE, or alternatively, an AS), a data repository, or alternatively, registry search (e.g., a query against an Internet based registry of one or more formats for interaction and immersion metadata), or a selection of pre-configured resources (e.g., a selection of an application determined format for interaction and immersion metadata).

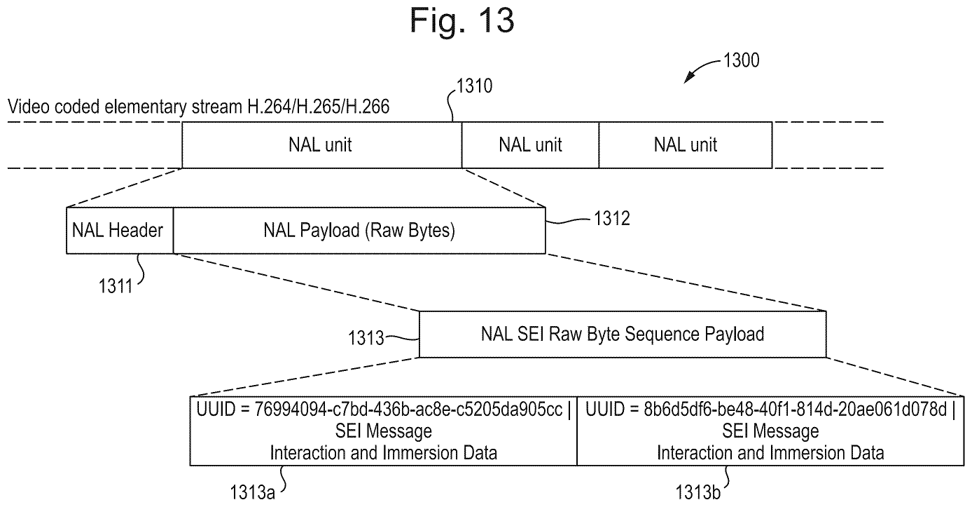

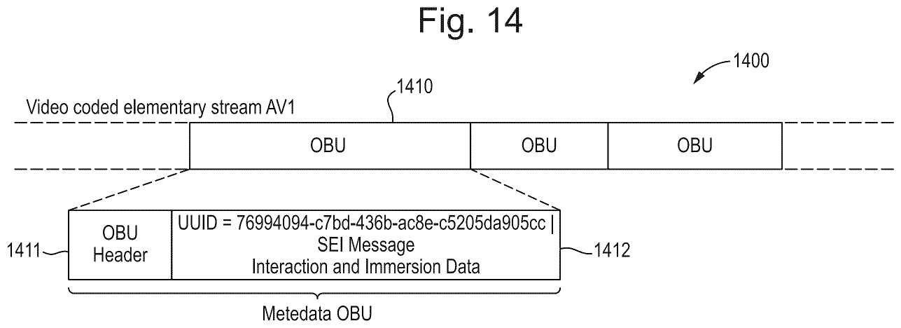

An example realization of interaction and immersion metadata for various video codecs (e.g., H.264/H.265/H.266) elementary streams is outlined at a high-level in FIGS. 13 and 14.

FIG. 13 illustrates a representation 1300 of multimedia interaction and immersion user data as metadata within a video coded elementary stream for MPEG H-26x family of video codecs. Illustrated for a given NAL unit 1310 is a NAL header 1311 and a NAL payload (Raw Bytes) 1312. The NAL payload 1312 comprises a NAL SEI Raw Byte Sequence Payload 1313 which itself comprises first and second SEI messages 1313a and 1313b. The first SEI message 1313a is illustrated as, “UUID=76994094-c7bd-436b-ac8e-c5205da905cc” and “SEI Message” and “Interaction and Immersion Data”. The second SEI message 1313b is illustrated as, “UUID=8b6d5df6-be48-40f1-814d-20ae061d078d” and “SEI Message” and “Interaction and Immersion Data”.

FIG. 14 illustrates a representation 1400 of multimedia interaction and immersion user data as metadata within a video coded elementary stream for the AV1 video codec. Illustrated for a given OBU 1410 as a metadata OBU is an OBU header 1411 and OBU payload 1412, the OBU payload 1412 comprising a UUID illustrated as “UUID=76994094-c7bd-436b-ac8e-c5205da905cc” and further illustrated as “Interaction and Immersion Data”.

In some embodiments, the unique type identifier field may be unique within the scope of an application domain, or alternatively an application session, i.e., as a local type identifier for the syntax and semantics of the interaction and immersion metadata payload. An example of a local UUID may be in some implementations an application defined UUID mapped to a specific format for the interaction and immersion metadata payload. In some other embodiments, the unique type identifier may be globally unique, i.e., as a global type identifier for the syntax and semantics of the interaction and immersion metadata payload. One example of a global UUID may be in some implementations an UUID comprised in a global registry of formats for the interaction and immersion metadata.

The packetization over RTP/SRTP/WebRTC will now be discussed in relation to certain embodiments.

In some embodiments, the transport of the generated video elementary stream containing the interaction and immersion data is performed by an application based on at least one RTP, and SRTP protocol stack, whereby the video elementary stream makes up for an RTP/SRTP media stream containing the interaction and immersion user data. In one example, an AR application using RTP to send UL video traffic capturing the user view captured by AR glasses cameras may embed at the frames per second (FPS) of the video stream pose information regarding the user head orientation and pose. In this example, the application may use one of the H.264/H.265/H.266, or alternatively, AV1 video codecs to transport additionally over the video RTP stream the user pose and head orientation information as interaction and immersion metadata as described herein. An RTP receiver running the remote AR application logic may in turn receive the video RTP stream and access the interaction and immersion metadata embedded with the RTP video stream as the stream is decoded by the associated decoder.

In some embodiments, the transport of the generated video elementary stream containing the interaction and immersion data is performed by an application based on the WebRTC stack. In such an embodiment, the transport of the interaction and immersion data is done on top of SRTP, which transports over a network the video elementary stream containing the interaction and immersion data of the application.

In some embodiments, the signaling of such a media stream is based on legacy SDP signaling. In such embodiments, the application logic at an RTP/SRTP sender endpoint is responsible to signal to the remote application logic at an RTP/SRTP receiver endpoint an identifier regarding information necessary to the parsing of the interaction and immersion user data syntax and semantics.

Additionally, the decoder handling of immersion and interaction metadata will also be briefly discussed, with reference to certain embodiments.

In some embodiments, an RTP, or alternatively, an SRTP receiver may receive a video media stream including interaction and immersion metadata as described therein. The RTP, or alternatively, the SRTP receiver will process the received RTP/SRTP packets, extract the payload according to the RTP/SRTP protocol and buffer the payload outputs as an elementary stream towards an appropriate video decoder, e.g., a H.264/H.265/H.266 decoder, or alternatively, an AV1 decoder. The video decoder may further process the elementary stream in decoding the video coded content. In some embodiments, the decoder may detect the elementary stream components, e.g., NALU SEI messages of type user_data_unregistered or metadata OBU of type unregistered user private, containing the interaction and immersion metadata, and in turn the decoders will skip processing the latter.

In some embodiments, the video decoder may expose through some interface to the application logic, e.g., raw buffers, APIs such as a callback function, event handler, function pointer, the payload contents of the elementary stream components containing the interaction and immersion metadata, e.g., as SEI message payload in H.264/H.265/H.266, or equivalently, as AV1 metadata OBU payload. The application will consequently access the interaction and immersion metadata and be able to parse it and process it further for various operations based in part on the UUID identifying the metadata to a syntax and semantics determined format.

The disclosure herein proposes a novel method for the transport of interaction and immersion data of XR applications. The proposed transport is based on in-band encapsulation of said data as metadata within an associated video elementary stream applicable to all major modern video codecs, i.e., H.264, H.265, H.266 and AV1. The proposed transport is further based on a video codec common format comprised of two fields wherein the first field acts as identifier of the data syntax and semantics associated with the interaction and immersion metadata format used in the second field.

Some major advantages of the proposed solution are piggybacking the network transport on top of RTP/SRTP/WebRTC protocol stacks to benefit from real-time timing, synchronization, jitter management and FEC robustness features included in this family of transport protocols; and transparent processing through (i.e., passthrough) the media codec processing chain given availability of HW-accelerated and non-HW accelerated encoder/decoder programming libraries and interfaces.

Conveyed differently, the problem solved by this disclosure is the real-time transport of interaction and immersion multimedia data specific to interactive and immersive applications such as XR applications. The user interaction data (e.g., hand/face/body tracking, hand inputs) can be generated with various sizes in frequent data bursts at high frequency on par with the FPS of associated XR video streams. Such interaction data has real-time constraints as this data provides inputs to immersive XR applications. XR applications are constrained by low E2E budgets to deliver a high QoE for interactive and immersive applications and as such real-time transport solutions for such data are necessary.

The invention solves the problem by leveraging the fact that interaction and immersion data traffic is highly correlated with associated video stream traffic of XR applications. As such the proposal is to piggyback on the latter and existing video codecs capabilities to embed metadata in an elementary video stream. The method proposes the usage of user data SEI messages (H.264, H.265, H.266) and OBU metadata (AV1) for the transport of interaction and immersion multimedia data within an associated video elementary stream. The invention then relies on RTP/SRTP/WebRTC for the real-time transport over a network exploiting the benefits of existing protocols.

The proposed solution is superior to the data channel approach using WebRTC SCTP stack as it benefits of the advantages of RTP/SRTP, i.e., timing, synchronization, jitter management, reliability based on FEC. Furthermore, the proposed method inherently synchronizes the interaction and immersion metadata with one or more video streams that are used for piggybacking.

The proposed solution offers benefits beyond the RTP header extension approach as it does not limit the maximum payload size for an interaction and immersion multimedia data type. Furthermore, the proposed solution is transported as part of the RTP payload and thus benefits of RTP payload

The proposed solution is a trade-off with respect to the approach of defining a new IETF RTP payload for interaction and immersion multimedia data. The trade-off is mainly targeted at circumventing the need of providing a full RTP payload type specification.

A first embodiment provides interaction and immersion metadata transport over a video elementary stream as non-video coded user data metadata. The embodiment proposes to package the interaction & immersion data as a payload of at least two fields. The first field is an identifier (e.g., UUID) of the type (incl. syntax and semantics) of the data. The second field is carrying the relevant information formatted accordingly to the identifier of the first field. The payload is then embedded via a video encoder into the video elementary stream as a non-video coded metadata (e.g., as SEI messages for H.26x MPEG codecs, or alternatively, as OBU metadata for AV1). The generated video stream is transported as a regular AVP media stream over RTP/SRTP. On the receiver side the video decoder will skip and passthrough the non-video coded metadata and thus expose it to the application layer which can consume it according to the in-band signaled UUID present in the first field of the payload. In certain embodiments, the invention may utilise APIs and interfaces existing in video encoder/decoders.

From the perspective of a sender or transmitting entity, the disclosure herein provides a method for transmission of multimedia data by an endpoint over a network, the method comprising of: sampling interaction and immersion multimedia data as non-video coded data from one or more media sources; (encapsulating the sampled non-video coded interaction and immersion multimedia data into one or more non-video coded payloads, each comprising at least two fields; controlling a video encoder to generate a video coded elementary stream comprising the one or more non-video coded payloads and one or more video coded payloads; transmitting the video coded elementary stream based on a real-time transport protocol over the network to a remote endpoint.

Some embodiments further comprise a first field indicating an identifier for a syntax and semantics representation format of the interaction and immersion multimedia data, and a second field encoding the information the interaction and immersion multimedia data according to the representation format determined by the first field identifier indication.

In some embodiments the first field comprises a universally unique identifier (UUID) indication.

In some embodiments the first field indication comprises one of: a local identifier, being unique to the scope of at least one of an application or a session; and a global identifier, being unique to the scope of any application or session.

Some embodiments further comprise the interaction and immersion multimedia data comprising of at least one of: a user viewpoint description (in some embodiments this can be an encoding of azimuth, elevation, tilt, and associated ranges of motion describing the projection of the user view to a target display, whereas in other embodiments this can be an indication of a user field of view as the extent of the visible world from the viewer perspective described in the angular domain, e.g., radians/degrees, over vertical and horizontal planes); a user pose data representation (as for instance a timestamped 3D positional vector and quaternion representation of an XR space describing a pose object orientation up to 6DoF. Such a pose object may correspond to a user body component or segment, such as head, joints, hands or a combination thereof); a user gesture tracking data representation (i.e., an array of one or more hands tracked according to their pose, each hand tracking additionally consisting of an array of hand joint locations and velocities relative to a base XR space, for example, as per OpenXR OpenXR_EXT_hand_tracking API specification); a user body tracking data representation (e.g., a BioVision Hierarchical (BVH) encoding of the body and body segments movements and associated pose object); a user facial features tracking data representation (e.g., as an array of key points/features positions, pose, or their encoding to pre-determined facial expression classes); a set of one or more user actions (i.e., user actions and inputs to physical controllers or logic controllers defined within an XR space, for example as per OpenXR XrAction handle capturing diverse user inputs to controllers or HW command units supported by an AR/VR device compliant with OpenXR); and a set of one or more augmented reality (AR) object representations, each object comprising of at least one of a graphical description and an associated positional anchor (i.e., metadata determining the position of an object or a point in the XR space as an anchor for placing virtual 2D/3D objects, such as text renderings, static video content, 2D/3D video content etc.).

Some embodiments further comprise the video encoder encoding video based in part on at least one of: the H.264 video codec specification; H.265 video codec specification; H.266 video codec specification; and AV1 video codec specification.

In some embodiments, the encapsulated one or more payloads corresponding to non-video coded interaction and immersion multimedia data form one of: one or more supplemental enhancement information (SEI) messages of type user data unregistered; and one or more metadata open bitstream units (OBUs) of type unregistered user private data.

Some embodiments further comprise the real-time transport protocol to be in part at least one of encrypted and authenticated.

In some embodiments, the one or more media sources of the interaction and immersion non-video coded multimedia are peripherals of the endpoint corresponding to at least one of: one or more physical dedicated controllers; one or more RGB cameras; one or more RGBD cameras; one or more IR photo sensors; one or more microphones; and one or more haptic transducers.

From a receiver perspective, the disclosure herein provides a method for reception of multimedia data by an endpoint over a network, the method comprising of: receiving over the network based on a real-time transport protocol a video coded elementary stream from a remote endpoint, wherein the video coded elementary stream comprises of one or more video coded payloads and one or more non-video coded payloads; controlling a video decoder to generate a set of one or more information payloads corresponding to the non-video coded payloads, whereby each of non-video coded payloads comprises of at least two fields; processing the one or more information payloads as one or more samples of interaction and immersion multimedia data generated by one or more media sources.

Some embodiments further comprise a first field indicating an identifier for a syntax and semantics representation format of the interaction and immersion multimedia data, and a second field encoding the information the interaction and immersion multimedia data according to the representation format determined by the first field identifier indication.

In some embodiments the first field comprises a universally unique identifier (UUID) indication.

In some embodiments the first field indication comprises one of: a local identifier, being unique to the scope of at least one of an application or a session; and a global identifier, being unique to the scope of any application or session.

Some embodiments further comprise the interaction and immersion multimedia data comprising of at least one of: a user viewpoint description (in some embodiments this can be an encoding of azimuth, elevation, tilt, and associated ranges of motion describing the projection of the user view to a target display, whereas in other embodiments this can be an indication of a user field of view as the extent of the visible world from the viewer perspective described in the angular domain, e.g., radians/degrees, over vertical and horizontal planes); a user pose data representation (as for instance a timestamped 3D positional vector and quaternion representation of an XR space describing a pose object orientation up to 6DoF. Such a pose object may correspond to a user body component or segment, such as head, joints, hands or a combination thereof); a user gesture tracking data representation (i.e., an array of one or more hands tracked according to their pose, each hand tracking additionally consisting of an array of hand joint locations and velocities relative to a base XR space, for example, as per OpenXR OpenXR_EXT_hand_tracking API specification); a user body tracking data representation (e.g., a BioVision Hierarchical (BVH) encoding of the body and body segments movements and associated pose object); a user facial features tracking data representation (e.g., as an array of key points/features positions, pose, or their encoding to pre-determined facial expression classes); a set of one or more user actions (i.e., user actions and inputs to physical controllers or logic controllers defined within an XR space, for example as per OpenXR XrAction handle capturing diverse user inputs to controllers or HW command units supported by an AR/VR device compliant with OpenXR); and a set of one or more augmented reality (AR) object representations, each object comprising of at least one of a graphical description and an associated positional anchor (i.e., metadata determining the position of an object or a point in the XR space as an anchor for placing virtual 2D/3D objects, such as text renderings, static video content, 2D/3D video content etc.).

Some embodiments further comprise the video decoder decoding video based in part on at least one of: the H.264 video codec specification; H.265 video codec specification; H.266 video codec specification; and AV1 video codec specification.

In some embodiments, the encapsulated one or more payloads corresponding to non-video coded interaction and immersion multimedia data form one of: one or more supplemental enhancement information (SEI) messages of type user data unregistered; and one or more metadata open bitstream units (OBUs) of type unregistered user private data.

Some embodiments further comprise the real-time transport protocol to be in part at least one of encrypted and authenticated.

In some embodiments, the one or more media sources of the interaction and immersion non-video coded multimedia are peripherals of the endpoint corresponding to at least one of: one or more physical dedicated controllers; one or more RGB cameras; one or more RGBD cameras; one or more IR photo sensors; one or more microphones; and one or more haptic transducers.

The contents of this disclosure are related in particular to using SEI messages/OBU metadata for transport of interaction and immersion metadata associated with XR applications.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communication standards, these examples are not intended to be the limit of the communication standards to which the disclosed method and apparatus may be applied. For example, while specific examples have been given in the context of 3GPP, the principles disclosed herein can also be applied to another wireless communication system, and indeed any communication system which uses routing rules.

The method may also be embodied in a set of instructions, stored on a computer

readable medium, which when loaded into a computer processor, Digital Signal Processor (DSP) or similar, causes the processor to carry out the hereinbefore described methods.

Where referred to, the OpenXR specification is described in git reference release 1.0.26, RTP payload format media types are available in IANA standard RFC4855, and an SDP offer/answer model is described in RFC standard 3264 titled “An offer/answer model with the Session Description Protocol (SDP)”.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field addressed by this document: 3GPP, 3rd generation partnership project; 5G, fifth generation; 5GS, 5G System; 5QI, 5G QoS Identifier; AF, application function; AMF, access and mobility function; AR, augmented reality; DL, downlink; DTLS, datagram transport layer security; NAL, network abstraction layer; NALU, NAL unit; OBU, open bitstream unit; PCF, policy control function; PDU, packet data unit; PPS, picture parameter set; QoE, quality of experience; QoS, quality of service; RAN, radio access network; RTCP, real-time control protocol; RTP, real-time protocol; SDAP, service data adaptation protocol; SEI, supplemental enhancement information; SMF, session management function; SRTCP, secure real-time control protocol; SRTP, secure real-time protocol; TLS, transport layer security; UE, user equipment; UL, uplink; UPF, user plane function; VCL, video coding layer; VMAF, video multi-method assessment function; VPS, video parameter set; VR, virtual reality; WebRTC, web real-time communications; XR, extended reality; XR AS, XR application server; and XRM, XR media.

1. An apparatus for wireless communication, comprising:
at least one memory; and
at least one processor coupled with the at least one memory and configured to cause the apparatus to:
generate, using one or more media sources, one or more data units of multimedia immersion and interaction data;
encode, using a video codec, an encoded video stream, wherein the encoded video stream includes the one or more data units of multimedia immersion and interaction data as non-video coded embedded metadata; and
transmit, using a real-time transport protocol, the encoded video stream.

2. The apparatus of claim 1, wherein the non-video coded embedded metadata includes:
a first field comprising an identifier for a syntax and semantics representation format of the one or more data units of the multimedia immersion and interaction data; and
a second field comprising the one or more data units of the multimedia immersion and interaction data and encoded according to the syntax and semantics representation format corresponding to the identifier of the first field.

3. The apparatus of claim 2, wherein the identifier is a universally unique identifier (UUID) indication.

4. The apparatus of claim 3, wherein the UUID is unique to a specific application or session, or the UUID is globally unique.

5. The apparatus of claim 1, wherein the video codec includes a video codec selected from a list of video codecs, including:
an H.264 video codec specification;
an H.265 video codec specification;
an H.266 video codec specification; and
an AV1 video codec specification.

6. The apparatus of claim 5, wherein:
the video codec includes the H.264, H.265, or H.266 codec specifications, and wherein the at least one processor is configured to cause the apparatus to encode the video stream by causing the apparatus to encapsulate the non-video coded embedded metadata as a payload of user data in one or more supplemental enhancement information (SEI) messages of the type ‘user data unregistered’; or
the video codec includes the AV1 codec specification, and wherein the at least one processor is configured to cause the apparatus to encode the video stream by causing the apparatus to encapsulate the non-video coded embedded metadata as a payload of user data in one or more metadata open bitstream units (OBUs) of type ‘unregistered user private data’.

7. The apparatus of claim 1, wherein the real-time transport protocol includes a transport protocol selected from a list of transport protocols, including:
a real-time protocol (RTP);
a secure real-time protocol (SRTP); and
a web real-time communications (WebRTC).

8. The apparatus of claim 1, wherein the real-time transport protocol includes encryption and authentication.

9. The apparatus of claim 1, wherein the one or more media sources comprise peripherals selected from a of peripherals, including:
one or more physical dedicated controllers;
one or more red green blue (RGB) cameras;
one or more RGB-depth (RGBD) cameras;
one or more infrared (IR) cameras;
one or more microphones; and
one or more haptic transducers.

10. The apparatus of claim 1, wherein the one or more data units of multimedia immersion and interaction data includes immersion and interaction data, including:
a user viewpoint data;
a user field of view data;
a user pose/orientation data;
a user gesture tracking data;
a user body tracking data;
a user facial feature tracking data;
a user action and/or user input data;
a split rendering pose and spatial information; and
an augmented reality object representation including at least one of a graphical description of an object and an object positional anchor.

11. An apparatus for wireless communication, comprising:
at least one memory; and
at least one processor coupled with the at least one memory and configured to cause the apparatus to:
receive, using a real-time transport protocol, an encoded video stream, wherein the encoded video stream is encoded using a video codec and includes one or more data units of multimedia immersion and interaction data generated by one or more media sources as non-video coded embedded metadata;
decode, using the video codec, the encoded video stream to extract the non-video coded embedded metadata; and
consume the one or more data units of multimedia immersion and interaction data.

12. The apparatus of claim 11, wherein the non-video coded embedded metadata includes:
a first field comprising an identifier for a syntax and semantics representation format of the one or more data units of the multimedia immersion and interaction data; and
a second field comprising the one or more data units of the multimedia immersion and interaction data and encoded according to the syntax and semantics representation format corresponding to the identifier of the first field.

13. The apparatus of claim 12, wherein the identifier is a universally unique identifier (UUID) indication.

14. The apparatus of claim 13, wherein the UUID is unique to a specific application or session, or the UUID is globally unique.

15. The apparatus of claim 11, wherein the video codec includes a video codec selected from a list of video codecs, including:
an H.264 video codec specification;
an H.265 video codec specification;
an H.266 video codec specification; and
an AV1 video codec specification.

16. (canceled)

17. The apparatus of claim 11, wherein the real-time transport protocol includes a transport protocol selected from a list of transport protocols, including:
a real-time protocol (RTP);
a secure real-time protocol (SRTP);
a web real-time communications (WebRTC).

18. The apparatus of claim 11, wherein the real-time transport protocol includes encryption and authentication.

19. The apparatus of claim 11, wherein the one or more media sources include peripherals selected from a list of peripherals, including:
one or more physical dedicated controllers;
one or more red green blue ‘RGB’ cameras;
one or more RGB-depth ‘RGBD’ cameras;
one or more infrared ‘IR’ cameras;
one or more microphones; and
one or more haptic transducers.

20. (canceled)

21. A method performed by an apparatus, the method comprising:
generating, using one or more media sources, one or more data units of multimedia immersion and interaction data;
encoding, using a video codec, an encoded video stream, wherein the encoded video stream includes the one or more data units of multimedia immersion and interaction data as non-video coded embedded metadata; and
transmitting, using a real-time transport protocol, the encoded video stream.

22.-30. (canceled)

31. A method performed by an apparatus, the method comprising:
receiving, using a real-time transport protocol, an encoded video stream, wherein the encoded video stream is encoded using a video codec and includes one or more data units of multimedia immersion and interaction data generated by one or more media sources as non-video coded embedded metadata;
decoding, using the video codec, the encoded video stream to extract the non-video coded embedded metadata; and
consuming the one or more data units of multimedia immersion and interaction data.
